(19) United States
(12) Patent Application Publication
(10) Pub. No.: US 2019/0011380 A1
(43) Pub. Date: Jan. 10, 2019

(54) WAVE INTERFERENCE SYSTEMS AND METHODS FOR MEASURING OBJECTS AND WAVES

(71) Applicant: BRIGHAM YOUNG UNIVERSITY, Provo, UT (US)

(72) Inventors: Dallin S. Durfee, Orem, UT (US); Jarom Jackson, Provo, UT (US)

(21) Appl. No.: 16/030,520

(22) Filed: Jul. 9, 2018

Related U.S. Application Data
(60) Provisional application No. 62/530,742, filed on Jul. 10, 2017.
(60) Provisional application No. 62/577,285, filed on Oct. 26, 2017.

(51) Int. Cl. G01N 23/20; G01N 23/046

(52) U.S. Cl. CPC G01N 23/20075; G01N 23/046

(57) ABSTRACT

A method of measuring an object is disclosed. In one step, a first interference pattern of interference waves is created. In another step, first measurement information is measured by measuring the scattering of the first interference pattern off the object, the transmission of the first interference pattern through the object, or the transmission of the first interference pattern around the object. In yet another step, a second interference pattern of interfered waves is created having a different shape or different scale than the first interference pattern. In another step, second measurement information is measured by measuring the scattering of the second interference pattern off the object, the transmission of the second interference pattern through the object, or the transmission of the second interference pattern around the object. In still another step, measurements of the object are determined using knowledge about shape of the first and second interference patterns and the first and second measurement information.

### RELATED APPLICATION DATA

This application claims priority to U.S. Provisional Application No. 62/530,742, filed Jul. 10, 2017, and entitled Imaging With Patterned Light, and U.S. Provisional Application No. 62/577,285, filed Oct. 26, 2017, and entitled Structured Illumination Methods Using Wave Interference, of which the entire contents of each are hereby incorporated by reference in their entirety.

### GOVERNMENT RIGHTS

This disclosure was made with Government support under Grant PHY1205736 awarded by The National Science Foundation. The government has certain rights in the disclosure.

### FIELD OF THE DISCLOSURE

This disclosure relates to the use of wave interference patterns to measure and/or display objects and waves.

### BACKGROUND

Existing technology for measuring and/or displaying objects and waves typically require lenses, are usually limited in the resolving power that can be achieved to within a factor of two of the traditional Rayleigh criterion for the individual waves and optics used, and require optics to be located at short distances from the object in order to obtain high resolution.

A system and method is needed to overcome one or more issues of the existing technology for measuring objects and waves.

### SUMMARY

In one embodiment, a method of measuring an object is disclosed. In one step, a first interference pattern of interference waves is created. In another step, first measurement information is measured by measuring the scattering of the first interference pattern off the object, the transmission of the first interference pattern through the object, or the transmission of the first interference pattern around the object. In yet another step, a second interference pattern of interfered waves is created having a different shape or different scale than the first interference pattern. In another step, second measurement information is measured by measuring the scattering of the second interference pattern off the object, the transmission of the second interference pattern through the object, or the transmission of the second interference pattern around the object. In still another step, measurements of the object are determined using knowledge about shape of the first and second interference patterns and the first and second measurement information.

In another embodiment, a method of measuring or displaying a wave is disclosed. In one step, the wave is interfered with a first reference wave to create a first interference pattern. In another step, first measurement information is measured by measuring a first portion of the first interference pattern. In yet another step, a second interference pattern of interfered waves is created having a different shape or different scale than the first interference pattern. In another step, second measurement information is measured by measuring a second portion of the second interference pattern. In still another step, using the first and second measurement information, measurements of a phase or amplitude are determined at multiple locations of the wave, or an image or transformed image representation of the phase or amplitude of the wave in a plane is determined.

In still another embodiment, a method of measuring or displaying a wave is disclosed. In one step, the wave is interfered with a first reference wave to create a first interference pattern of interfered waves. In another step, first measurement information is measured by measuring the scattering of the first interference pattern off an object, the transmission of the first interference pattern through the object, or the transmission of the first interference pattern around the object. In still another step, a second interference pattern of interfered waves having a different shape or different scale than the first interference pattern is created. In yet another step, second measurement information is measured by measuring the scattering of the second interference pattern off the object, the transmission of the second interference pattern through the object, or the transmission of the second interference pattern around the object. In another step, using the first and the second measurement information, measurements of a phase or amplitude at multiple locations of the wave are determined, or an image or transformed image representation of the phase or amplitude of the wave in a plane is determined.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a box diagram of one embodiment of a system for measuring or displaying an object;

FIG. 2 illustrates a box diagram of another embodiment of a system for measuring or displaying an object;

FIG. 3 is a flowchart illustrating one embodiment of a method of measuring or displaying an object;

FIG. 4 is a flowchart illustrating another embodiment of a method of measuring or displaying an object;

FIG. 5 is a flowchart illustrating still another embodiment of a method of measuring or displaying an object;

FIG. 6 is a flowchart illustrating one embodiment of a method of measuring or displaying a wave;

FIG. 7 is a flowchart illustrating another embodiment of a method of measuring or displaying a wave;

FIG. 8 illustrates a box diagram of one embodiment of a system for measuring or displaying a wave;

FIG. 9 illustrates a box diagram of another embodiment of a system for measuring or displaying a wave;

FIG. 10 is a flowchart illustrating one embodiment of a method of measuring or displaying a wave;

FIG. 11 is a flowchart illustrating another embodiment of a method of measuring or displaying a wave; and

FIG. 12 is a flowchart illustrating yet another embodiment of a method of measuring or displaying a wave.

### DETAILED DESCRIPTION

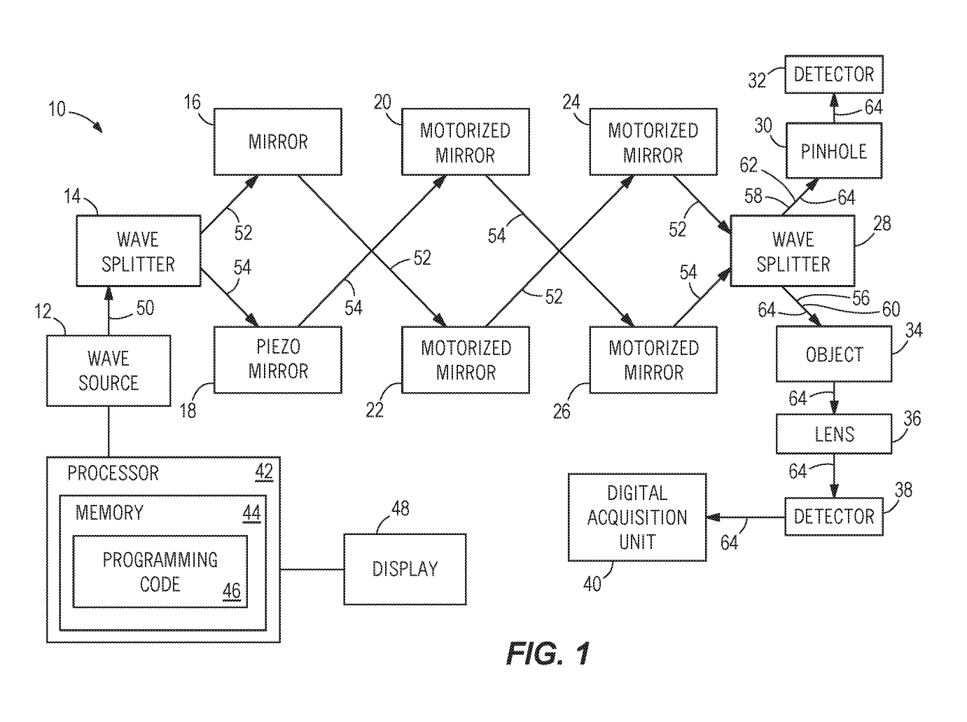

FIG. 1 illustrates a box diagram of one embodiment of a system 10 for measuring or displaying an object 34. The system 10 comprises wave source 12, wave splitter 14, mirror 16, piezo mirror 18, motorized mirror 20, motorized mirror 22, motorized mirror 24, motorized mirror 26, wave splitter 28, pinhole 30, detector 32, lens 36, detector 38, digital acquisition unit 40, processor 42, memory 44, programming code 46, and display 48. In other embodiments, the system 10 may have varying components in varying configurations. For instance, the lens 36 is not necessary and/or an inexpensive lens may be used.

The wave source 12 transmits a wave 50 towards the wave splitter 14. The wave 50 may comprise any type of wave such as an X-ray, laser beam, microwave, ultrasound wave, radio frequency wave, or other types of wave. The wave splitter 14 splits the wave 50 into identical waves 52 and 54. Wave 52 reflects off mirror 16, off motorized mirror 22, off motorized mirror 24, to wave splitter 28 which splits the wave 52 into identical waves 56 and 58. Wave 54 reflects off piezo mirror 18, off motorized mirror 20, off motorized mirror 26, to wave splitter 28 which splits the wave 54 into identical waves 60 and 62. Waves 58 and 62 form a first interference pattern 64 of interfered waves. Waves 56 and 60 form the identical first interference pattern 64 of interfered waves.

First interference pattern 64 of interfered waves 58 and 62 travels through pinhole 30 to detector 32. Pinhole 30 has a diameter of 1 micrometer. In other embodiments, the size of pinhole 30 may vary. Detector 32 detects the phase of the first interference pattern 64. First interference pattern 64 of interfered waves 56 and 60 scatters off, transmits through, or transmits around object 34, through lens 36, to detector 38. The signal generated by detector 38 is acquired by digital acquisition unit 40.

Processor 42 comprises memory 44 which contains the programming code 46. Programming code 46 comprises algorithmic instructions for operating the system 10. It is noted that for ease of illustration that connecting lines have not been drawn in FIG. 1 between the processor 42 and all components of the system 10. However, the processor 42 operates and controls the entire system 10. Processor 42 is in electronic communication with the components of the system 10 and controls the system 10 following the instructions in the programming code 46. Processor 42 stores and analyzes the data, regarding the first interference pattern 64, generated by the detector 32 and the detector 38/digital acquisition unit 40 in the memory 44 and uses this data to measure, as first measurement information, the scattering of the first interference pattern 64 off the object 34, the transmission of the first interference pattern 64 through the object 34, or the transmission of the first interference pattern 64 around the object 34.

Processor 42 causes the piezo mirror 18 and motorized mirrors 20, 22, 24, and 26 to move into another configuration relative to one another to create a second interference pattern of interfered waves, having a different shape or different scale than the first interference pattern 64 of interfered waves, which is also detected by detector 32 and detector 38/digital acquisition unit 40. For purposes of this disclosure, two interference patterns are not considered to have a different shape if they are the same under some set of rotations and/or translations. This data is stored in the memory 44 which is used by the processor 42 to measure, as second measurement information, the scattering of the second interference pattern off the object 34, the transmission of the second interference pattern through the object 34, or the transmission of the second interference pattern around the object 34.

Processor 42 determines the measurements of the object 34 based on knowledge about shape of the first and second interference patterns and the first and second measurement information. Processor 42 further determines an image or transformed image representation of the object 34 based on knowledge about shape of the first and second interference patterns and the first and second measurement information. It is noted that the processor 42 may cause any number of interference patterns, having different shapes or scales, to be generated and may measure the scattering of these varying interference patterns off the object 34, their transmission through the object 34, or their transmission around the object 34 in order to determine the measurements of the object 34, and to determine the image or transformed image representation of the object 34.

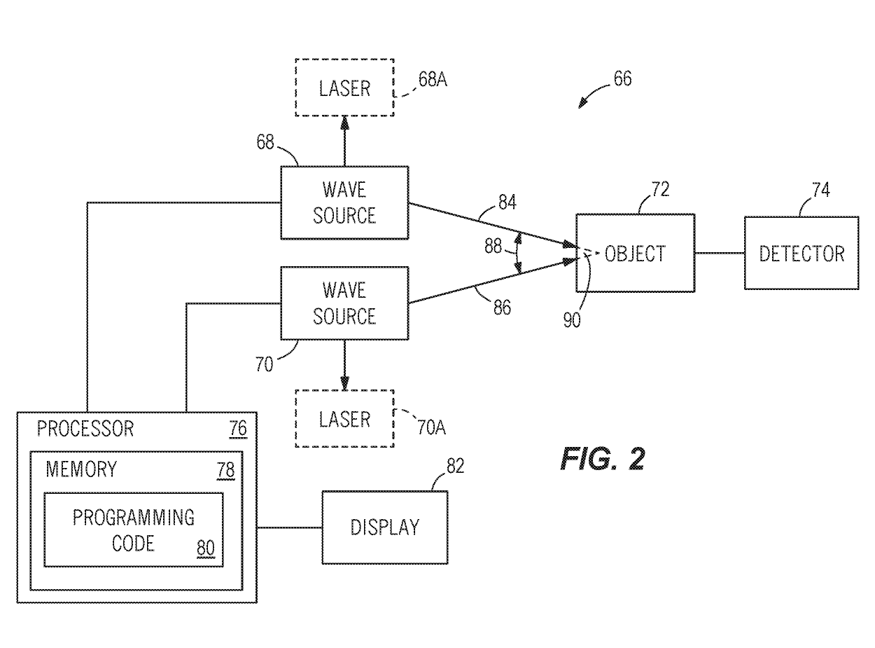

FIG. 2 illustrates a box diagram of another embodiment of a system 66 for measuring or displaying an object 72. The system 66 comprises wave source 68, wave source 70, detector 74, processor 76, memory 78, programming code 80, and display 82. In other embodiments, the system 66 may have varying components in varying configurations.

The wave source 66 transmits wave 84 towards the object 72. The wave 84 may comprise any type of wave such as an X-ray, laser beam, microwave, ultrasound wave, radio frequency wave, or other types of wave. The wave source 70 transmits wave 86 towards the object 72. The wave 86 may comprise any type of wave such as an X-ray, laser beam, microwave, ultrasound wave, radio frequency wave, or other types of wave. Waves 84 and 86 are at angle 88 relative to one another and form a first interference pattern 90 of interfered waves.

First interference pattern 90 of interfered waves 84 and 86 scatters off, transmits through, or transmits around object 72 to detector 74. Processor 76 comprises memory 78 which contains the programming code 80. Programming code 80 comprises algorithmic instructions for operating the system 66. Processor 76 is in electronic communication with the components of the system 66 and controls the system 66 following the instructions in the programming code 80. It is noted that for ease of illustration that connecting lines have not been drawn in FIG. 2 between the processor 76 and all components of the system 66. However, the processor 76 operates and controls the entire system 66. Processor 76 stores and analyzes the data, regarding the first interference pattern 90, generated by the detector 74 in the memory 78 and uses this data to measure, as first measurement information, the scattering of the first interference pattern 90 off the object 72, the transmission of the first interference pattern 90 through the object 72, or the transmission of the first interference pattern 90 around the object 72.

Processor 76 causes the wave source 68 and the wave source 70 to move to different positions 68A and 70A relative to one another to create a second interference pattern of interfered waves, having a different shape or different scale than the first interference pattern 90 of interfered waves, which is also detected by detector 74. This data is stored in the memory 78 which is used by the processor 76 to measure, as second measurement information, the scattering of the second interference pattern off the object 72, the transmission of the second interference pattern through the object 72, or the transmission of the second interference pattern around the object 72.

Processor 76 determines the measurements of the object 72 based on knowledge about shape of the first and second interference patterns and the first and second measurement information. Processor 76 further determines an image or transformed image representation of the object 72 based on knowledge about shape of the first and second interference patterns and the first and second measurement information. It is noted that the processor 76 may cause any number of interference patterns, having different shapes or scales, to be generated and may measure the scattering of these varying interference patterns off the object 72, their transmission through the object 72, or their transmission around the object 72 in order to determine the measurements of the object 72, and also to determine the image or transformed image representation of the object 72.

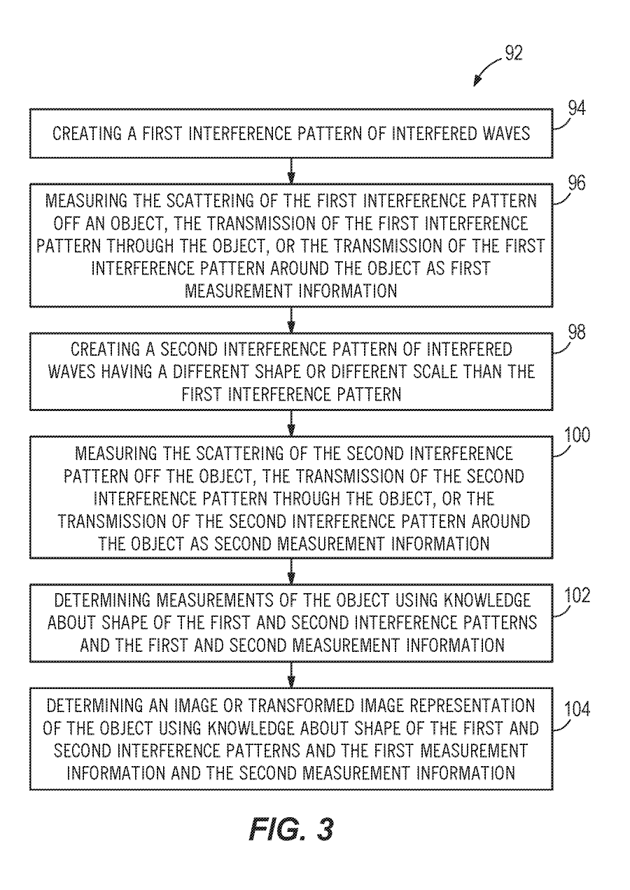

FIG. 3 is a flowchart illustrating one embodiment of a method 92 of measuring or displaying an object. The method 92 may utilize either of the systems of FIG. 1 or 2. Step 94 comprises creating a first interference pattern of interfered waves. The interfered waves may comprise any types of interfered waves such as X-rays, laser beams, microwaves, ultrasound waves, radio frequency waves, or other types of waves. Step 96 comprises measuring the scattering of the first interference pattern off an object, the transmission of the first interference pattern through the object, or the transmission of the first interference pattern around the object as first measurement information. Step 98 comprises creating a second interference pattern of interfered waves having a different shape or different scale than the first interference pattern. Step 100 comprises measuring the scattering of the second interference pattern off the object, the transmission of the second interference pattern through the object, or the transmission of the second interference pattern around the object as second measurement information. Step 102 comprises determining measurements of the object using knowledge about shape of the first and second interference patterns and the first and second measurement information. Step 104 comprises determining an image or transformed image representation of the object using knowledge about shape of the first and second interference patterns and the first measurement information and the second measurement information. In other embodiments, one or more steps of the method 92 may be modified in substance or in order, one or more steps may not be followed, or one or more additional steps may be added.

For instance, in one embodiment, the method 92 may be used in microscopy. It is noted that, unlike other prior art systems which require a lens to be close to the object for high resolution, in the disclosure resolution is not compromised by distance. In fact, in the disclosure, no optics are required to be placed near the object being imaged and a lens is not necessary or an inexpensive lens may be used. In another embodiment, the method 92 may be used to perform imaging with a resolution better than (λ/4n)\sqrt{1+(2s/x)²} where λ is the wavelength of a wave, n is an index of refraction of a medium surrounding the object, x is a largest measurement of a focusing element, and no focusing elements are placed closer to the object than s. In yet another embodiment, the method 92 comprises: creating at least twenty interference patterns of interfered waves of different shape or scale; measuring, as measurement information, the scattering of the at least twenty interference patterns off the object, the transmission of the at least twenty interference patterns through the object, or the transmission of the at least twenty interference patterns around the object; and determining the measurements of the object or determining the image or the transformed image representation of the object using knowledge about shape of the interference patterns and the measurement information.

It is noted that in previously existing methods using interference patterns as part of an imaging or measuring device all of the benefit can be gained from 10-20 such patterns. These methods use interference patterns to gain up to a 2× increase in resolution of the underlying imaging system, and usually do so with a single pattern under various rotations, though in some cases multiple patterns may be used. The full benefit of these methods is obtained with 10-20 such patterns, or rotations and translations of a pattern. No increase in resolution is obtained in these methods by simply using more patterns. The methods described in this patent continue to gather additional useful information with each and every pattern, even if millions of patterns are used.

In another embodiment, the method 92 further comprises determining a phase of the first and second interference patterns by measuring portions of the first interference pattern and the second interference pattern. In yet another embodiment, the method 92 further comprises using a spatial light modulator to create or modify a shape of the first or second interference patterns.

In one embodiment, steps 94 and 98 comprise creating the first and the second interference patterns by splitting a wave transmitted from only one wave source, and creating the second interference pattern of waves by moving a plurality of mirrors to different positions relative to one another. In another embodiment, steps 94 and 98 comprise creating the first and second interference patterns using a plurality of wave sources. In still another embodiment, step 98 comprises changing an angle between the interfered waves of the second interference pattern to be different than the angle between the interfered waves of the first interference pattern to create different sinusoidal interference patterns having different orientations and different fringe spacing.

In yet another embodiment, step 102 comprises using compressive sensing techniques to determine the measurements of the object. In one embodiment, steps 102 and 104 comprise doing a mathematical transform wherein a discrete or continuous function, represented in terms of a first set of basis functions, is transformed to be represented in a second set of basis functions. A transformed image refers to the data resulting from applying such a transform to image data. In another embodiment, step 104 comprises creating images of the object with a depth-of-field greater than eight times resolution squared divided by a wavelength of the interfered waves. In another embodiment, step 104 comprises creating a 3D image of the object using computed tomography. In still another embodiment, step 104 comprises creating a multi-spectral image of the object. It is noted that the multi-spectral image can be extended to an indefinite number of wavelengths.

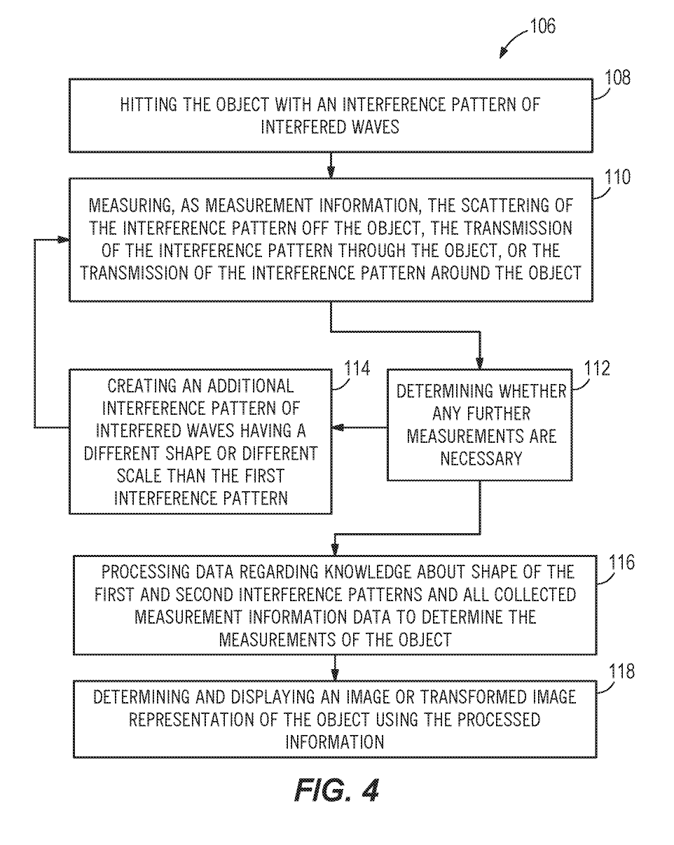

FIG. 4 is a flowchart illustrating another embodiment of a method 106 of measuring or displaying an object. The method 106 may utilize either of the systems of FIG. 1 or 2. Step 108 comprises hitting the object with an interference pattern of interfered waves. The interfered waves (defined as waves that overlap) may comprise any types of interfered waves such as X-rays, laser beams, microwaves, ultrasound waves, radio frequency waves, or other types of waves. The object can comprise any type of object such as a microscope slide when using lasers, a mountain when using radio waves, an asteroid when using satellites, and other types of objects needing measurement. The shape of the interference pattern must be known, measurable, or calculate-able. For instance, in one embodiment the angle between the interfered waves forming the interference pattern may be set and based on this angle a shape of the interference pattern may be calculated, and a phase of the interference pattern may then be measured. The interference pattern may comprise a 2D sine wave, repeating rings, a random noise pattern, or another type of interference pattern.

Step 110 comprises measuring, as measurement information, the scattering of the interference pattern off the object, the transmission of the interference pattern through the object, or the transmission of the interference pattern around the object. This measurement may comprise measuring the amplitude of some or part of the interference pattern as it scatters off the object, transmits through the object, or transmits around the object. A phase of the interference pattern may also be determined. This measurement may be done using any type of measurement/detection device or system for the particular interference pattern being measured/detected such as a radio antenna, a photodiode, a photo-multiplier tube, or another type of measurement/detection device or system.

Step 112 comprises determining whether any further measurements are necessary. This determination may be made based on varying criteria such as what object is being measured, the types of interference patterns used, the type of inverse transform needed, the field of view desired, the resolution desired, and other criteria. If the outcome of step 112 is that further measurements are necessary, then the method proceeds from step 112 to step 114. If the outcome of step 112 is that no further measurements are necessary, then the method proceeds to step 116.

Step 114 comprises creating an additional interference pattern of interfered waves having a different shape or different scale than the first interference pattern. This may be done in varying ways such as by changing a frequency, changing an angle between wave sources creating the interference pattern, using a liquid crystal or micro mirror device in one or more wave sources to change the interference pattern, moving mirrors to change the interference pattern, or using other mechanisms. The additional interference pattern must be known, measurable, or calculate-able. For instance, in one embodiment the angle between the interfered waves forming the additional interference pattern may be set and based on this angle a shape of the additional interference pattern may then be calculated, and a phase of the additional interference pattern may then be measured. The additional interference pattern may comprise a 2D sine wave, repeating rings, a random noise pattern, or another type of additional interference pattern.

The method then proceeds from step 114 back to step 110 and measures, as additional measurement information, the scattering of the additional interference pattern off the object, the transmission of the additional interference pattern through the object, or the transmission of the additional interference pattern around the object. The method then proceeds from step 110 back to step 112 and determines whether any further measurements are necessary. The loop of step 112, to step 114, to step 110, and back to step 112 is continued to take additional measurements using varying shaped or scaled interference patterns until the outcome of step 112 is that no further measurements are necessary at which point the method proceeds to step 116.

In step 116, knowledge about shape of the first and second interference patterns and all the measurement information data collected in step 110 is processed to determine the measurements of the object. This step may comprise any type of processing such as doing an inverse transform (such as a Fourier Transform or applying a compressive sensing algorithm), or other type of processing.

In step 118, an image or transformed image representation of the object is determined and displayed using the processed information. In other embodiments, one or more steps of the method 106 may be modified in substance or in order, one or more steps may not be followed, or one or more additional steps may be added.

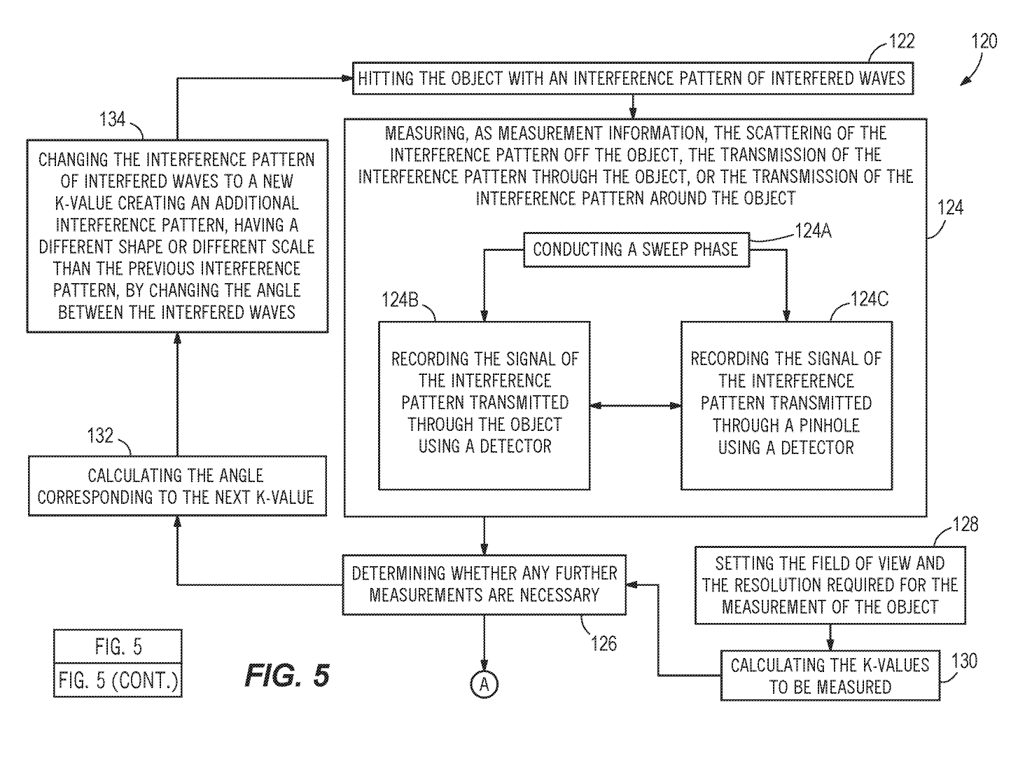

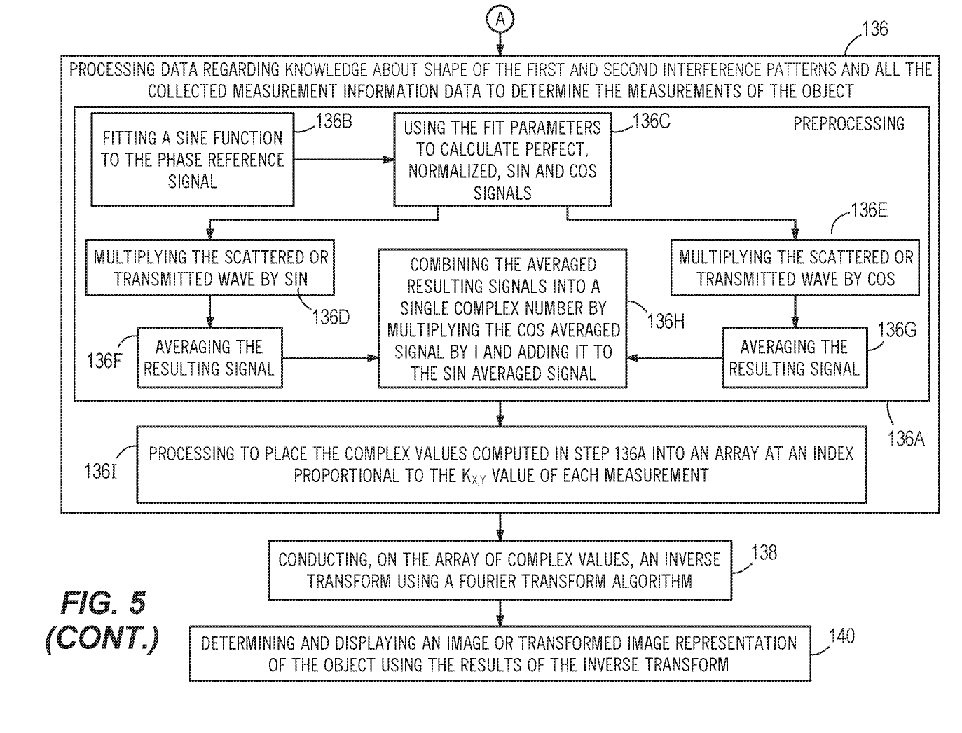

FIG. 5 is a flowchart illustrating still another embodiment of a method 120 of measuring or displaying an object. The method 120 may utilize either of the systems of FIG. 1 or 2. Step 122 comprises hitting the object with an interference pattern of interfered waves. The interfered waves (defined as waves that overlap) may comprise any types of interfered waves such as X-rays, laser beams, microwaves, ultrasound waves, radio frequency waves, or other types of waves. The object can comprise any type of object such as a microscope slide when using lasers, a mountain when using radio waves, an asteroid when using satellites, and other types of objects needing measurement. The shape of the interference pattern must be known, measurable, or calculate-able. For instance, in one embodiment the angle between the interfered waves forming the interference pattern may be set and based on this angle a shape of the interference pattern can then be calculated, and a phase of the interference pattern then measured. The interference pattern may comprise a 2D sine wave, repeating rings, a random noise pattern, or another type of interference pattern.

Step 124 comprises measuring, as measurement information, the scattering of the interference pattern off the object, the transmission of the interference pattern through the object, or the transmission of the interference pattern around the object. Step 124 comprises steps 124A, 124B, and 124C. In step 124A, a sweep phase is done. This may be done using a piezo mounted mirror, ramping the voltage (to increase linearly in time) on the piezo-electric crystals causing the mirror to smoothly move on a tiny scale, or using other components, systems, or methods. This effectively sweeps the phase difference between waves, resulting in the interference pattern shifting with time. In step 124B, the signal of the interference pattern transmitted through the object is recorded by a detector. In step 124C, done simultaneously as step 124B, the signal of the interference pattern transmitted through a pinhole is recorded using a detector. The measurements of steps 124B and 124C may be done using any type of measurement/detection device or system for the particular interference pattern being measured/detected such as a radio antenna, a photodiode, a photo-multiplier tube, or another type of measurement/detection device or system.

Step 126 comprises determining whether any further measurements are necessary using the information provided in steps 128 and 130. Step 128 comprises setting the field of view (FOV) and the resolution required for the measurement of the object. This determines the spacing and maximum of the k-values at which the object needs to be scanned. Step 130 comprises calculating the k-values to be measured. These may be set using the following field of view and resolution: kₘₐₓ=1/2δx, where δx is the desired resolution and Δk=1/FOV, where Δk is the needed (maximum) spacing between measurements in k-space. The k-values at which to make the measurements are determined over the range from −kₘₐₓ to kₘₐₓ in both the x and y directions. If the outcome of step 126 is that further measurements are necessary, then the method proceeds from step 126 to step 132. If the outcome of step 126 is that no further measurements are necessary, then the method proceeds to step 136.

Step 132 comprises calculating the angle corresponding to the next k-value. For each k-value the fringe spacing d must be set to d=(kₓ²+k_{y}²)^{-1/2}. The angle θ between waves is calculated from the expression d=λ/[2 sin(θ/2)] where λ is the laser wavelength. The necessary orientation of the pattern, given by the direction of the vector \vec{k}=(kₓ, k_{y}) is used to determine the azimuthal angle. The waves should be crossing at the image point on a plane perpendicular to the fringe direction.

After step 132, the method 120 proceeds to step 134 during which the interference pattern of interfered waves is changed to a new k-value creating an additional interference pattern, having a different shape or different scale than the previous interference pattern, by changing the angle between the interfered waves. The interference pattern may be set by moving motorized motors in an interferometer to steer the waves onto the object at the desired angle and orientation while keeping their position centered and overlapping. The additional interference pattern may comprise a 2D sine wave, repeating rings, a random noise pattern, or another type of additional interference pattern.

The method then proceeds from step 134 back to step 122 and hits the object with the additional interference pattern. The method then proceeds to step 124 and measures as measurement information, following the steps of 124A, 124B, and 124C, the scattering of the additional interference pattern off the object, the transmission of the additional interference pattern through the object, or the transmission of the additional interference pattern around the object. The method then proceeds to step 126 and determines whether any further measurements are necessary using the information provided in steps 128 and 130. The loop of step 126, to step 132, to step 134, to step 122, to step 124, and back to step 126 is continued to take additional measurements using additional interference patterns having new k-values until the outcome of step 126 is that no further measurements are necessary at which point the method proceeds to step 136.

In step 136, knowledge about shape of the first and second interference patterns and all the measurement information data collected in step 124 is processed to determine the measurements of the object. Step 136 comprises steps 136A, 136B, 136C, 136D, 136E, 136F, 136G, 136H, and 136I. Step 136A comprises preprocessing. Step 136A is necessary since at the time of measurement only the spacing of the fringes could be calculated and not the phase. Step 136A comprises steps 136B, 136C, 136D, 136E, 136F, 136G, and 136H. Step 136B comprises fitting a sine function to the phase reference signal. After step 136B, step 136C comprises using the fit parameters to calculate perfect, normalized, sin and cos signals. After step 136C, steps 136D and 136E comprise separately multiplying each of the sin and cos signals by the signal from the scattered or transmitted wave. Step 136F, after step 136D, comprises averaging the resulting signal of step 136D. Step 136G, after step 136E, comprises averaging the resulting signal of step 136E. Step 136H, after steps 136F and 136G, comprises combining the averaged resulting signals of steps 136F and 136G into a single complex number by multiplying the cos averaged signal by i and adding it to the sin averaged signal.

Step 136A is done separately for each measurement from each interference pattern. Step 136I, after step 136A, comprises processing to place the complex values computed in step 136A into an array at an index proportional to the k_{x,y} value of each measurement. The resulting array is effectively the discrete Fourier transform of the desired image.

Step 138, after step 136I, comprises conducting, on the array of complex values of step 136I, an inverse transform using a Fourier Transform algorithm. Step 140, after step 138, comprises determining and displaying an image or transformed image representation of the object using the results of the inverse transform of step 138. In other embodiments, one or more steps of the method 120 may be modified in substance or in order, one or more steps may not be followed, or one or more additional steps may be added.

In another embodiment, the system 10 of FIG. 1 may be used to measure or display the wave 50 from the wave source 12 rather than the object 34. This is achieved by substituting a blank screen for the object 34 of FIG. 1 and leaving all other components the same.

In still another embodiment, the system 66 of FIG. 2 may be used to measure or display the wave 84 from the wave source 84 rather than the object 72. This is achieved by substituting a blank screen for the object 72 of FIG. 2 and leaving all other components the same.

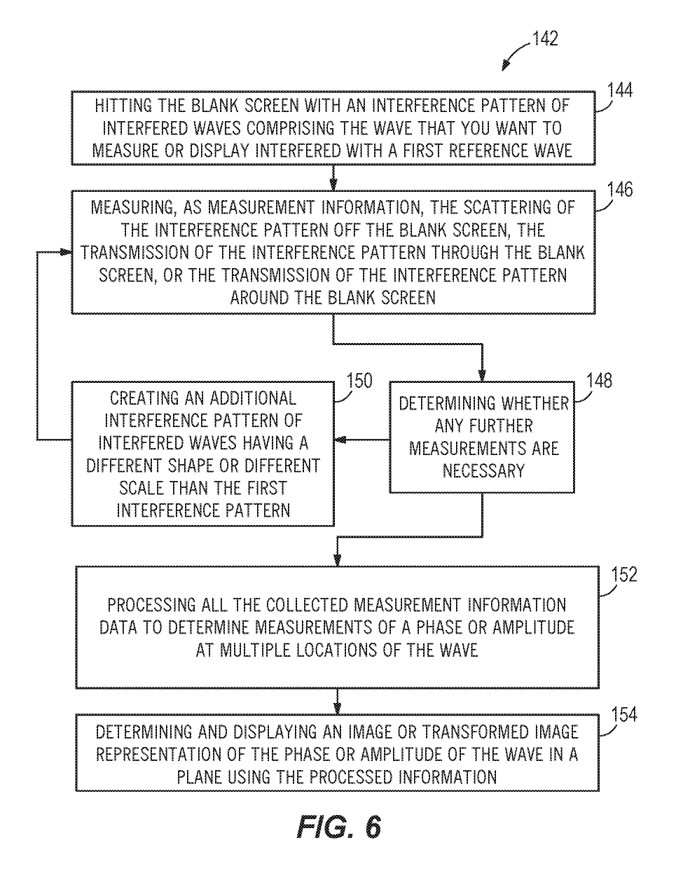

FIG. 6 is a flowchart illustrating one embodiment of a method 142 of measuring or displaying a wave. The method 142 may utilize the system 10 of FIG. 1 by substituting a blank screen for the object 34, or may utilize the system 66 of FIG. 2 by substituting a blank screen for the object 72. Step 144 comprises hitting the blank screen with an interference pattern of interfered waves comprising the wave that you want to measure or display interfered with a first reference wave. The reference waves can be derived from the wave being measured, or can be an independent wave. The interfered waves (defined as waves that overlap) may comprise any types of interfered waves such as X-rays, laser beams, microwaves, ultrasound waves, radio frequency waves, or other types of waves. In one embodiment the angle between the interfered waves forming the interference pattern may be set and based on this angle a shape of the interference pattern that would result from flat wavefronts may be calculated, and a phase of the interference pattern may then be measured. The interference pattern may comprise a 2D sine wave, repeating rings, a random noise pattern, or another type of interference pattern.

Step 146 comprises measuring, as measurement information, the scattering of the interference pattern off the blank screen, the transmission of the interference pattern through the blank screen, or the transmission of the interference pattern around the blank screen. This measurement may comprise measuring the amplitude of some or part of the interference pattern as it scatters off the blank screen, transmits through the blank screen, or transmits around the blank screen. A phase of the interference pattern may also be determined. This measurement may be done using any type of measurement/detection device or system for the particular interference pattern being measured/detected such as a radio antenna, a photodiode, a photo-multiplier tube, or another type of measurement/detection device or system.

Step 148 comprises determining whether any further measurements are necessary. This determination may be made based on varying criteria such as what wave is being measured, the types of interference patterns used, the type of inverse transform needed, the field of view desired, the resolution desired, and other criteria. If the outcome of step 148 is that further measurements are necessary, then the method proceeds from step 148 to step 150. If the outcome of step 148 is that no further measurements are necessary, then the method proceeds to step 152.

Step 150 comprises creating an additional interference pattern of interfered waves having a different shape or different scale than the first interference pattern. This may be done in varying ways such as by changing a frequency, changing an angle between wave sources creating the interference pattern, using a liquid crystal or micro mirror device in one or more wave sources to change the interference pattern, moving mirrors to change the interference pattern, or using other mechanisms. In one embodiment the angle between the interfered waves forming the additional interference pattern may be set and based on this angle a shape of the interference pattern that would result from flat wavefronts may be calculated, and a phase of the additional interference pattern may then be measured. The additional interference pattern may comprise a 2D sine wave, repeating rings, a random noise pattern, or another type of additional interference pattern.

The method then proceeds from step 150 back to step 146 and measures, as additional measurement information, the scattering of the additional interference pattern off the blank screen, the transmission of the additional interference pattern through the blank screen, or the transmission of the additional interference pattern around the blank screen. The method then proceeds from step 146 back to step 148 and determines whether any further measurements are necessary. The loop of step 148, to step 150, to step 146, and back to step 148 is continued to take additional measurements using varying shaped or scaled interference patterns until the outcome of step 148 is that no further measurements are necessary at which point the method proceeds to step 152.

In step 152, all the measurement information data collected in step 146 is processed to determine measurements of a phase or amplitude at multiple locations of the wave. This step may comprise any type of processing such as doing an inverse transform (such as a Fourier Transform or applying a compressive sensing algorithm), or other type of processing.

In step 154, an image or transformed image representation of the phase or amplitude of the wave in a plane is determined and displayed using the processed information. In other embodiments, one or more steps of the method 142 may be modified in substance or in order, one or more steps may not be followed, or one or more additional steps may be added.

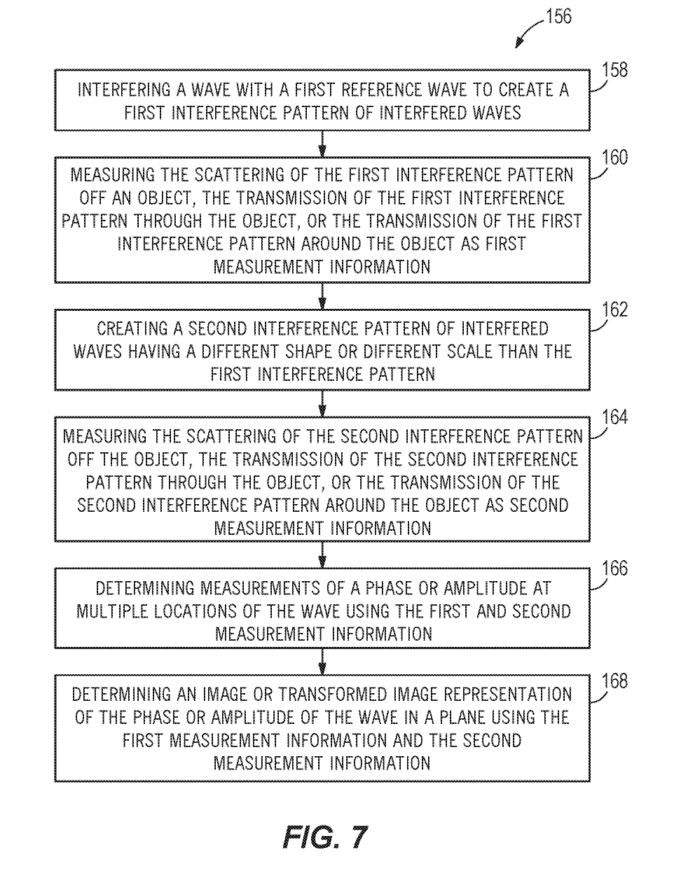

FIG. 7 is a flowchart illustrating another embodiment of a method 156 of measuring or displaying a wave. The method 156 may utilize the system 10 of FIG. 1 by substituting a blank screen for the object 34, or may utilize the system 66 of FIG. 2 by substituting a blank screen for the object 72. Step 158 comprises interfering a wave with a first reference wave to create a first interference pattern of interfered waves. The interfered waves may comprise any types of interfered waves such as X-rays, laser beams, microwaves, ultrasound waves, radio frequency waves, or other types of waves. Step 160 comprises measuring the scattering of the first interference pattern off an object, the transmission of the first interference pattern through the object, or the transmission of the first interference pattern around the object as first measurement information. The object may comprise a blank screen. Step 162 comprises creating a second interference pattern of interfered waves having a different shape or different scale than the first interference pattern. Step 164 comprises measuring the scattering of the second interference pattern off the object, the transmission of the second interference pattern through the object, or the transmission of the second interference pattern around the object as second measurement information. Step 166 comprises determining measurements of a phase or amplitude at multiple locations of the wave using the first and second measurement information. Step 168 comprises determining an image or transformed image representation of the phase or amplitude of the wave in a plane using the first measurement information and the second measurement information. In other embodiments, one or more steps of the method 156 may be modified in substance or in order, one or more steps may not be followed, or one or more additional steps may be added.

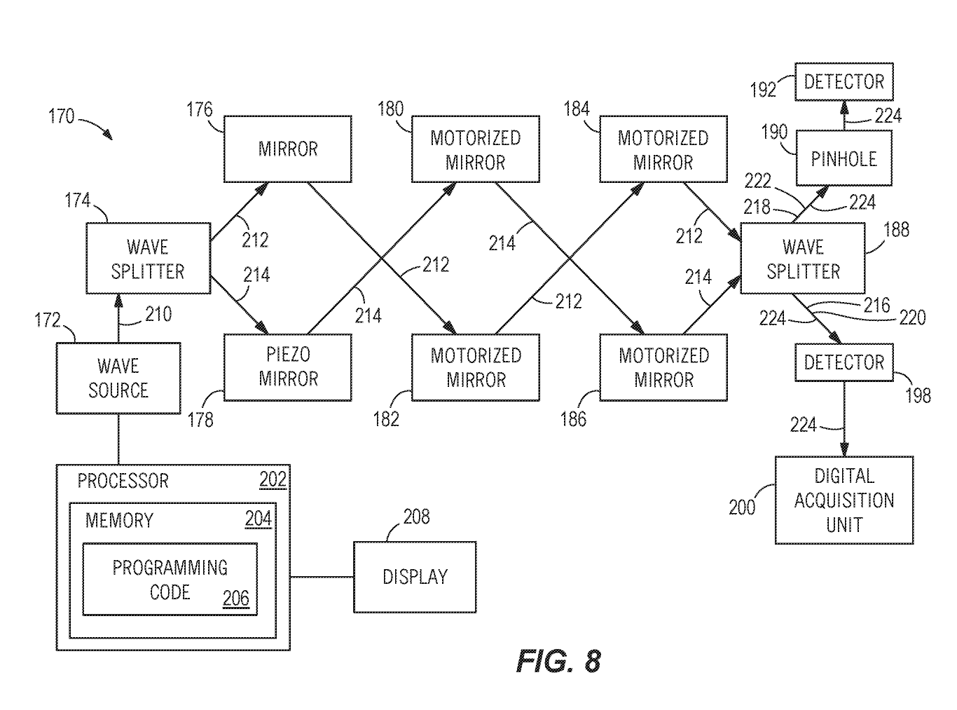

FIG. 8 illustrates a box diagram of one embodiment of a system 170 for measuring or displaying a wave. The system 170 comprises wave source 172, wave splitter 174, mirror 176, piezo mirror 178, motorized mirror 180, motorized mirror 182, motorized mirror 184, motorized mirror 186, wave splitter 188, pinhole 190, detector 192, detector 198, digital acquisition unit 200, processor 202, memory 204, programming code 206, and display 208. In other embodiments, the system 170 may have varying components in varying configurations.

The wave source 172 transmits a wave 210 towards the wave splitter 174. The wave 210 may comprise any type of wave such as an X-ray, laser beam, microwave, ultrasound wave, radio frequency wave, or other types of wave. The wave splitter 174 splits the wave 210 into identical waves 212 and 214. Wave 212 reflects off mirror 176, off motorized mirror 182, off motorized mirror 184, to wave splitter 188 which splits the wave 212 into identical waves 216 and 218. Wave 214 reflects off piezo mirror 178, off motorized mirror 180, off motorized mirror 186, to wave splitter 188 which splits the wave 214 into identical waves 220 and 222. Waves 218 and 222 form a first interference pattern 224 of interfered waves. Waves 216 and 220 form the identical first interference pattern 224 of interfered waves.

First interference pattern 224 of interfered waves 218 and 222 travels through pinhole 190 to detector 192. Pinhole 190 has a diameter of 1 micrometer. In other embodiments, the size of pinhole 190 may vary. Detector 192 detects the phase of the first interference pattern 224. First interference pattern 224 of interfered waves 216 and 220 transmits to detector 198. The signal generated by detector 198 is acquired by digital acquisition unit 200.

Processor 202 comprises memory 204 which contains the programming code 206. Programming code 206 comprises algorithmic instructions for operating the system 170. Processor 202 is in electronic communication with the components of the system 170 and controls the system 170 following the instructions in the programming code 206. It is noted that for ease of illustration that connecting lines have not been drawn in FIG. 8 between the processor 202 and all components of the system 170. However, the processor 202 operates and controls the entire system 170. Processor 202 stores and analyzes the data, regarding the first interference pattern 224, generated by the detector 192 and the detector 198/digital acquisition unit 200 in the memory 204 and uses this data to measure, as first measurement information, a first portion of the first interference pattern 224.

Processor 202 causes the piezo mirror 178 and motorized mirrors 180, 182, 184, and 186 to move into another configuration relative to one another to create a second interference pattern of interfered waves, having a different shape or different scale than the first interference pattern 224 of interfered waves, which is also detected by detector 192 and detector 198/digital acquisition unit 200. This data is stored in the memory 204 which is used by the processor 202 to measure, as second measurement information, a second portion of the second interference pattern.

Processor 202 determines the measurements of a phase or amplitude at multiple locations of the wave 210 based on the first and second measurement information. Processor 202 further determines an image or transformed image representation of the phase or amplitude of the wave 210 in a plane based on the first and second measurement information. It is noted that the processor 202 may cause any number of interference patterns, having different shapes or scales, to be generated and may measure portions of these interference patterns in order to determine the measurements of a phase or amplitude at multiple locations of the wave 210, and to determine the image or transformed image representation of the phase or amplitude of the wave 210 in a plane.

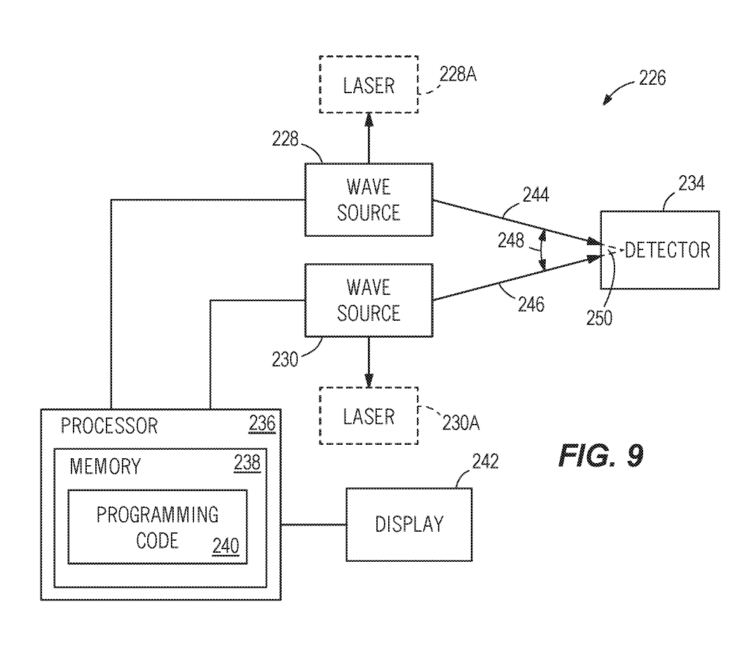

FIG. 9 illustrates a box diagram of another embodiment of a system 226 for measuring or displaying a wave 244. The system 226 comprises wave source 228, wave source 230, detector 234, processor 236, memory 238, programming code 240, and display 242. In other embodiments, the system 226 may have varying components in varying configurations.

The wave source 228 transmits wave 244 towards the detector 234. The wave 244 may comprise any type of wave such as an X-ray, laser beam, microwave, ultrasound wave, radio frequency wave, or other types of wave. The wave source 230 transmits wave 246 towards the detector 234. The wave 246 may comprise any type of wave such as an X-ray, laser beam, microwave, ultrasound wave, radio frequency wave, or other types of wave. Waves 244 and 246 are at angle 248 relative to one another and form a first interference pattern 250 of interfered waves.

First interference pattern 250 of interfered waves 244 and 246 is detected by the detector 234. Processor 236 comprises memory 238 which contains the programming code 240. Programming code 240 comprises algorithmic instructions for operating the system 226. Processor 236 is in electronic communication with the components of the system 226 and controls the system 226 following the instructions in the programming code 240. It is noted that for ease of illustration that connecting lines have not been drawn in FIG. 9 between the processor 236 and all components of the system 226. However, the processor 236 operates and controls the entire system 226. Processor 236 stores and analyzes the data generated by the detector 234, regarding a first portion of the first interference pattern 250, and uses this data to measure first measurement information regarding the first portion of the first interference pattern 250.

Processor 236 causes the wave source 228 and the wave source 230 to move to different positions 228A and 230A relative to one another to create a second interference pattern of interfered waves, having a different shape or different scale than the first interference pattern 250 of interfered waves, which is also detected by detector 234. This data is stored in the memory 238 which is used by the processor 236 to measure, as second measurement information, a second portion of the second interference pattern.

Processor 236 determines the measurements of a phase or amplitude at multiple locations of the wave 244 based on the first and second measurement information. Processor 236 further determines an image or transformed image representation of the phase or amplitude of the wave 244 in a plane using the first and second measurement information. It is noted that the processor 236 may cause any number of interference patterns, having different shapes or scales, to be generated and may measure portions of these interference patterns in order to determine measurements of a phase or amplitude at multiple locations of the wave 244, and also to determine the image or transformed image representation of the phase or amplitude of the wave 244 in a plane using the first and second measurement information.

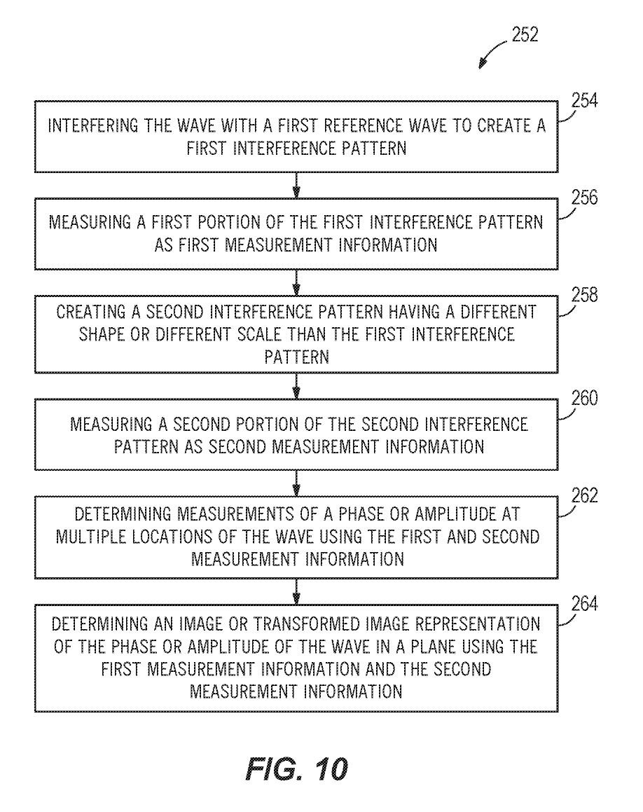

FIG. 10 is a flowchart illustrating one embodiment of a method 252 of measuring or displaying a wave. The method 252 may utilize either of the systems of FIG. 8 or 9. Step 254 comprises interfering the wave with a first reference wave to create a first interference pattern. The wave and the first reference wave may comprise any types of waves such as X-rays, laser beams, microwaves, ultrasound waves, radio frequency waves, or other types of waves. Step 256 comprises measuring a first portion of the first interference pattern as first measurement information. Step 258 comprises creating a second interference pattern having a different shape or different scale than the first interference pattern. Step 260 comprises measuring a second portion of the second interference pattern as second measurement information. Step 262 comprises determining measurements of a phase or amplitude at multiple locations of the wave using the first and second measurement information. Step 264 comprises determining an image or transformed image representation of the phase or amplitude of the wave in a plane using the first measurement information and the second measurement information. In other embodiments, one or more steps of the method 252 may be modified in substance or in order, one or more steps may not be followed, or one or more additional steps may be added.

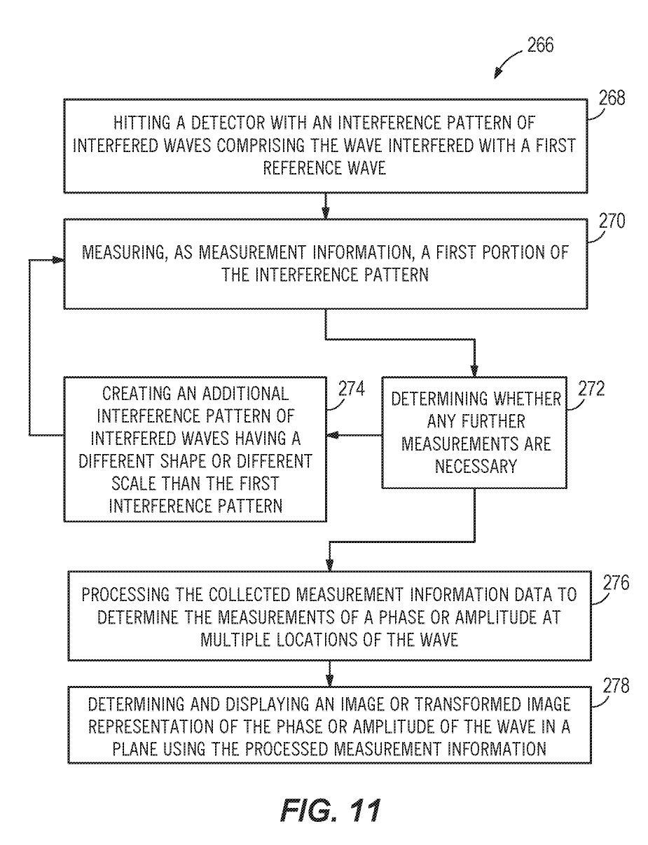

FIG. 11 is a flowchart illustrating another embodiment of a method 266 of measuring or displaying a wave. The method 266 may utilize either of the systems of FIG. 8 or 9. Step 268 comprises hitting a detector with an interference pattern of interfered waves comprising the wave interfered with a first reference wave. The reference wave can be derived from the wave being measured, or can be an independent wave. The interfered waves (defined as waves that overlap) may comprise any types of interfered waves such as X-rays, laser beams, microwaves, ultrasound waves, radio frequency waves, or other types of waves. In one embodiment the angle between the interfered waves forming the interference pattern may be set and based on this angle a shape of the interference pattern that would result from flat wavefronts may be calculated, and a phase of the interference pattern may then be measured. The interference pattern may comprise a 2D sine wave, repeating rings, a random noise pattern, or another type of interference pattern.

Step 270 comprises measuring, as measurement information, a first portion of the interference pattern. This measurement may comprise measuring the amplitude of some or part of the interference pattern. A phase of the interference pattern may also be determined. This measurement may be done using any type of measurement/detection device or system for the particular interference pattern being measured/detected such as a radio antenna, a photodiode, a photo-multiplier tube, or another type of measurement/detection device or system.

Step 272 comprises determining whether any further measurements are necessary. This determination may be made based on varying criteria such as what wave is being measured, the types of interference patterns used, the type of inverse transform needed, the field of view desired, the resolution desired, and other criteria. If the outcome of step 272 is that further measurements are necessary, then the method proceeds from step 272 to step 274. If the outcome of step 272 is that no further measurements are necessary, then the method proceeds to step 276.

Step 274 comprises creating an additional interference pattern of interfered waves having a different shape or different scale than the first interference pattern. This may be done in varying ways such as by changing a frequency, changing an angle between wave sources creating the interference pattern, using a liquid crystal or micro mirror device in one or more wave sources to change the interference pattern, moving mirrors to change the interference pattern, or using other mechanisms. In one embodiment the angle between the interfered waves forming the additional interference pattern may be set and based on this angle a shape of the interference pattern that would result from flat wavefronts may be calculated, and a phase of the additional interference pattern may then be measured. The additional interference pattern may comprise a 2D sine wave, repeating rings, a random noise pattern, or another type of additional interference pattern.

The method then proceeds from step 274 back to step 270 and measures, as additional measurement information, a second portion of the additional interference pattern. The method then proceeds from step 270 back to step 272 and determines whether any further measurements are necessary. The loop of step 272, to step 274, to step 270, and back to step 272 is continued to take additional measurements using varying shaped or scaled interference patterns until the outcome of step 272 is that no further measurements are necessary at which point the method proceeds to step 276.

In step 276, all the measurement information data collected in step 270 is processed to determine the measurements of a phase or amplitude at multiple locations of the wave. This step may comprise any type of processing such as doing an inverse transform (such as a Fourier Transform or applying a compressive sensing algorithm), or other type of processing.

In step 278, an image or transformed image representation of the phase or amplitude of the wave in a plane is determined and displayed using the processed measurement information. In other embodiments, one or more steps of the method 266 may be modified in substance or in order, one or more steps may not be followed, or one or more additional steps may be added.

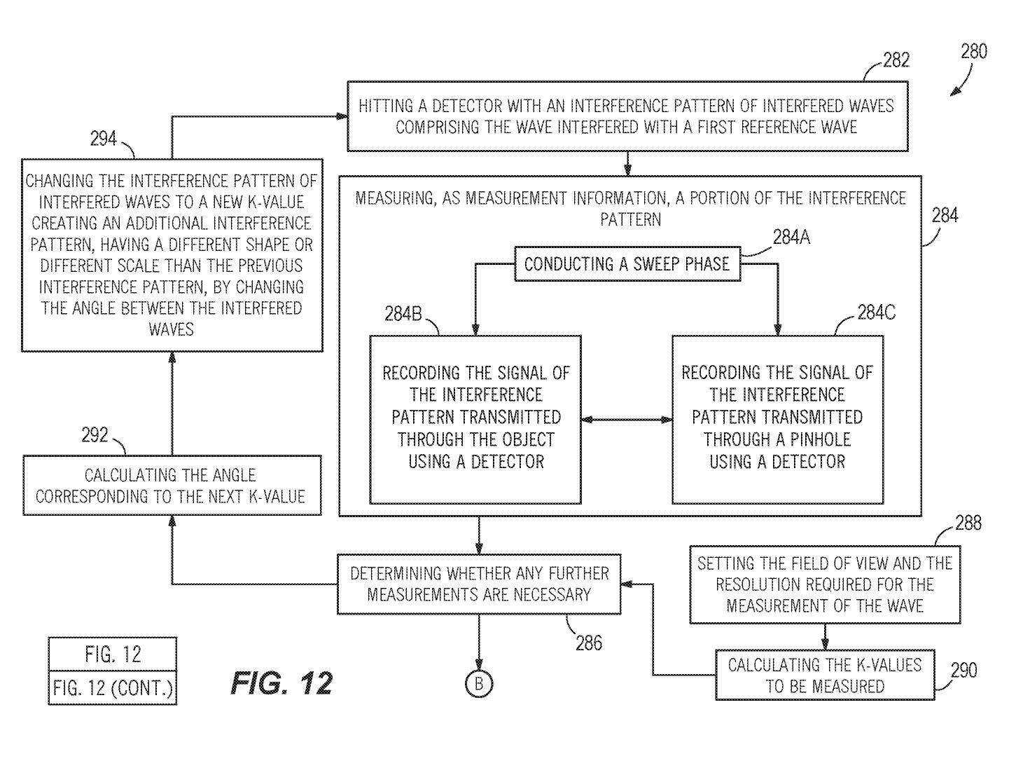

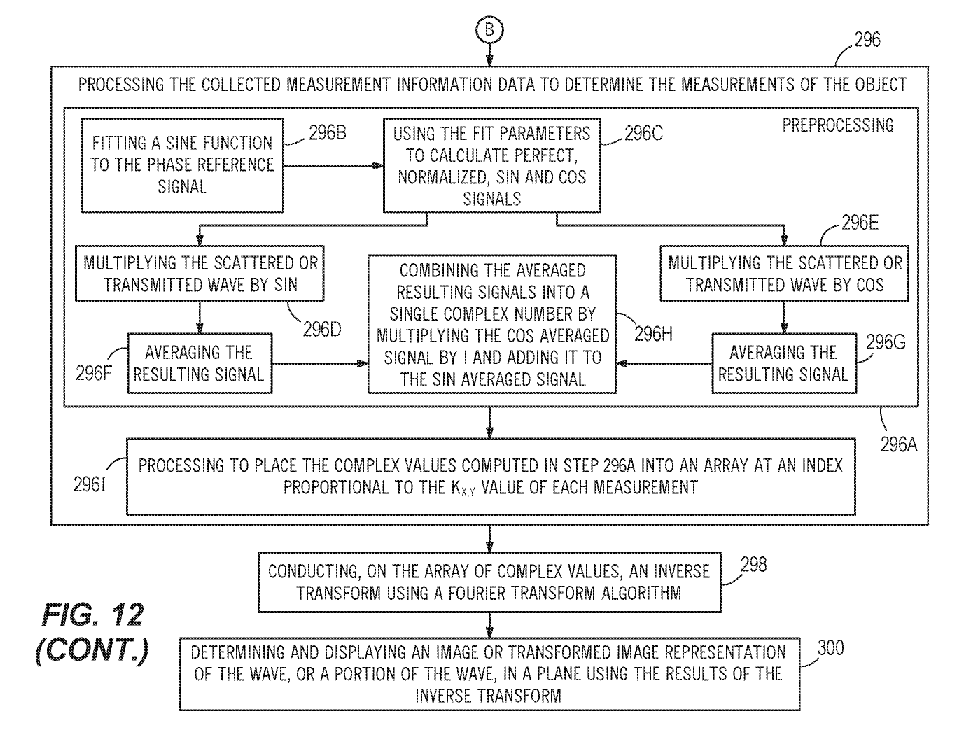

FIG. 12 is a flowchart illustrating yet another embodiment of a method 280 of measuring or displaying a wave. The method 280 may utilize either of the systems of FIG. 8 or 9. Step 282 comprises hitting a detector with an interference pattern of interfered waves comprising the wave interfered with a first reference wave. The reference wave can be derived from the wave being measured, or can be an independent wave. The interfered waves (defined as waves that overlap) may comprise any types of interfered waves such as X-rays, laser beams, microwaves, ultrasound waves, radio frequency waves, or other types of waves. In one embodiment the angle between the interfered waves forming the interference pattern may be set and based on this angle a shape of the interference pattern that would result from flat wavefronts can then be calculated, and a phase of the interference pattern then measured. The interference pattern may comprise a 2D sine wave, repeating rings, a random noise pattern, or another type of interference pattern.

Step 284 comprises measuring, as measurement information, a portion of the interference pattern. Step 284 comprises steps 284A, 284B, and 284C. In step 284A, a sweep phase is done. This may be done using a piezo mounted mirror, ramping the voltage (to increase linearly in time) on the piezo-electric crystals causing the mirror to smoothly move on a tiny scale, or using other components, systems, or methods. This effectively sweeps the phase difference between waves, resulting in the interference pattern shifting with time. In step 284B, the signal of the interference pattern transmitted through the object is recorded using a detector. In step 284C, done simultaneously as step 284B, the signal of the interference pattern transmitted through a pinhole is recorded with a detector. The measurements of steps 284B and 284C may be done using any type of measurement/detection device or system for the particular interference pattern being measured/detected such as a radio antenna, a photodiode, a photo-multiplier tube, or another type of measurement/detection device or system.

Step 286 comprises determining whether any further measurements are necessary using the information provided in steps 288 and 290. Step 288 comprises setting the field of view (FOV) and the resolution required for the measurement of the wave. This determines the spacing and maximum of the k-values at which the wave needs to be scanned. Step 290 comprises calculating the k-values to be measured. These may be set using the following field of view and resolution: kₘₐₓ=1/2δx, where δx is the desired resolution and Δk=1/FOV, where Δk is the needed (maximum) spacing between measurements in k-space. The k-values at which to make the measurements are determined over the range from −kₘₐₓ to kₘₐₓ in both the x and y directions. If the outcome of step 286 is that further measurements are necessary, then the method proceeds from step 286 to step 292. If the outcome of step 286 is that no further measurements are necessary, then the method proceeds to step 296.

Step 292 comprises calculating the angle corresponding to the next k-value. For each k-value the fringe spacing d must be set to d=(kₓ²+k_{y}²)^{-1/2}. The angle θ between waves is calculated from the expression d=λ/[2 sin(θ/2)] where λ is the laser wavelength. The necessary orientation of the pattern, given by the direction of the vector \vec{k}=(kₓ, k_{y}) is used to determine the azimuthal angle. The waves should be crossing at the image point on a plane perpendicular to the fringe direction.

After step 292, the method 280 proceeds to step 294 during which the interference pattern of interfered waves is changed to a new k-value creating an additional interference pattern, having a different shape or different scale than the interference pattern, by changing the angle between the interfered waves. The interference pattern may be set by moving motorized mirrors in an interferometer to steer the waves onto the object at the desired angle and orientation while keeping their position centered and overlapping. The additional interference pattern may comprise a 2D sine wave, repeating rings, a random noise pattern, or another type of additional interference pattern.

The method then proceeds from step 294 back to step 282 and hits the detector with the additional interference pattern. The method then proceeds to step 284 and measures as measurement information, following the steps of 284A, 284B, and 284C, a second portion of the additional interference pattern. The method then proceeds to step 286 and determines whether any further measurements are necessary using the information provided in steps 288 and 290. The loop of step 286, to step 292, to step 294, to step 282, to step 284, and back to step 286 is continued to take additional measurements using additional interference patterns having new k-values until the outcome of step 286 is that no further measurements are necessary at which point the method proceeds to step 296.

In step 296, all the measurement information data collected in step 284 is processed to determine the measurements of a phase or amplitude at multiple locations of the wave. Step 296 comprises steps 296A, 296B, 296C, 296D, 296E, 296F, 296G, 296H, and 296I. Step 296A comprises preprocessing. Step 296A is necessary unless the phase of the interference can be precisely controlled. Step 296A comprises steps 296B, 296C, 296D, 296E, 296F, 296G, and 296H. Step 296B comprises fitting a sine function to the phase reference signal. After step 296B, step 296C comprises using the fit parameters to calculate perfect, normalized, sin and cos signals. After step 296C, steps 296D and 296E comprise separately multiplying each of the sin and cos signals by the scattered or transmitted wave. Step 296F, after step 296D, comprises averaging the resulting signal of step 296D. Step 296G, after step 296E, comprises averaging the resulting signal of step 296E. Step 296H, after steps 296F and 296G, comprises combining the averaged resulting signals of steps 296F and 296G into a single complex number by multiplying the cos averaged signal by i and adding it to the sin averaged signal.

Step 296A is done separately for each measurement from each interference pattern. Step 296I, after step 296A, comprises processing to place the complex values computed in step 296A into an array at an index proportional to the k_{x,y} value of each measurement. The resulting array is effectively the discrete Fourier transform of the desired image.

Step 298, after step 296I, comprises conducting, on the array of complex values of step 296I, an inverse transform using a Fourier Transform algorithm. Step 300, after step 298, comprises determining and displaying an image or transformed image representation of the wave or a portion of the wave in a plane using the results of the inverse transform of step 298. In other embodiments, one or more steps of the method 280 may be modified in substance or in order, one or more steps may not be followed, or one or more additional steps may be added.

One or more embodiments of the disclosure overcome one or more issues associated with existing technology for measuring and/or displaying objects. For instance, the disclosure does not require lenses or an inexpensive lens may be used. The disclosure is not limited in the resolving power that can be achieved to the traditional Rayleigh criterion for the individual waves used. The disclosure does not require optics to be located at short distances from the object in order to obtain high resolution.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A method of measuring an object comprising:
creating a first interference pattern of interfered waves;
measuring the scattering of the first interference pattern off the object, the transmission of the first interference pattern through the object, or the transmission of the first interference pattern around the object as first measurement information;
creating a second interference pattern of interfered waves having a different shape or different scale than the first interference pattern;
measuring the scattering of the second interference pattern off the object, the transmission of the second interference pattern through the object, or the transmission of the second interference pattern around the object as second measurement information; and
determining measurements of the object using knowledge about shape of the first and second interference patterns and the first and second measurement information.

2. The method of claim 1 further comprising determining an image or transformed image representation of the object using the knowledge about the shape of the first and the second interference patterns and the first measurement information and the second measurement information.

3. The method of claim 1 further comprising using the method in microscopy.

4. The method of claim 1 further comprising using the method to perform imaging with a resolution better than (λ/4n)\sqrt{1+(2s/x)²} where λ is the wavelength of a wave, n is an index of refraction of a medium surrounding the object, x is a largest measurement of a focusing element, and no focusing elements are placed closer to the object than s.

5. The method of claim 1 wherein the creating the first and the second interference patterns comprises creating the first and the second interference patterns by splitting a wave transmitting from only one wave source, and the creating the second interference pattern of waves having the different shape or the different scale than the first interference pattern comprises moving a plurality of mirrors to different positions.

6. The method of claim 1 wherein the creating the first and the second interference patterns comprises creating the first and the second interference patterns by using a plurality of wave sources.

7. The method of claim 1 wherein the creating the second interference pattern comprises changing an angle between the interfered waves of the second interference pattern to be different than the angle between the interfered waves of the first interference pattern.

8. The method of claim 7 wherein the changing the angle between the interfered waves of the second interference pattern to be different than the angle between the interfered waves of the first interference pattern creates different sinusoidal interference patterns having different orientations and different fringe spacing.

9. The method of claim 1 wherein the determining the measurements of the object using the first measurement information and the second measurement information comprises doing a mathematical transform wherein a discrete or continuous function, represented in terms of a first set of basis functions, is transformed to be represented in a second set of basis functions.

10. The method of claim 1 comprising: creating at least twenty interference patterns of interfered waves of different shape or scale; measuring, as measurement information, the scattering of the at least twenty interference patterns off the object, the transmission of the at least twenty interference patterns through the object, or the transmission of the at least twenty interference patterns around the object; and determining the measurements of the object or determining the image or the transformed image representation of the object using the measurement information and the knowledge about shape of the interference patterns.

11. The method of claim 1 further comprising creating images of the object with a depth-of-field greater than eight times resolution squared divided by a wavelength of the interfered waves.

12. The method of claim 1 wherein the method is used to create a 3D image of the object using computed tomography.

13. The method of claim 1 wherein the method is used to create a multi-spectral image of the object.

14. The method of claim 1 wherein the interfered waves comprise x-rays.

15. The method of claim 1 further comprising determining a phase of the first and second interference patterns by measuring portions of the first interference pattern and the second interference pattern.

16. The method of claim 1 wherein compressive sensing techniques are used during determining the measurements of the object.

17. The method of claim 1 further comprising using a spatial light modulator to create or modify a shape of the first or second interference patterns.

18. A method of measuring or displaying a wave comprising:
interfering the wave with a first reference wave to create a first interference pattern;
measuring a first portion of the first interference pattern as first measurement information;
creating a second interference pattern having a different shape or different scale than the first interference pattern;
measuring a second portion of the second interference pattern as second measurement information; and
determining measurements of a phase or amplitude at multiple locations of the wave or determining an image or transformed image representation of the phase or amplitude of the wave in a plane using the first measurement information and the second measurement information.

19. A method of measuring or displaying a wave comprising:
interfering the wave with a first reference wave to create a first interference pattern of interfered waves;
measuring the scattering of the first interference pattern off an object, the transmission of the first interference pattern through the object, or the transmission of the first interference pattern around the object as first measurement information;
creating a second interference pattern of interfered waves having a different shape or different scale than the first interference pattern;
measuring the scattering of the second interference pattern off the object, the transmission of the second interference pattern through the object, or the transmission of the second interference pattern around the object as second measurement information; and
determining measurements of a phase or amplitude at multiple locations of the wave or determining an image or transformed image representation of the phase or amplitude of the wave in a plane using the first measurement information and the second measurement information.

20. The method of claim 19 wherein the object comprises a blank screen.
